(19) United States
(12) Patent Application Publication
(10) Pub. No.: US 2026/0204640 A1
(43) Pub. Date: Jul. 16, 2026

(54) HIGH ENTROPY LIQUID ELECTROLYTES FOR LI-ION OR NA-ION BATTERIES

(71) Applicant: TECHNISCHE UNIVERSITEIT DELFT, Delft (NL)

(72) Inventors: Marnix WAGEMAKER, Delft (NL); Qidi WANG, Delft (NL); Chenglong ZHAO, Delft (NL)

(73) Assignee: TECHNISCHE UNIVERSITEIT DELFT, Delft (NL)

(21) Appl. No.: 19/137,241

(22) PCT Filed: Dec. 7, 2023
(86) PCT No.: PCT/NL2023/050642

§ 371 Date: Jun. 9, 2025

(30) Foreign Application Priority Data
Dec. 9, 2022 (NL) 2033704

(51) Int. Cl. H01M 10/0568; H01M 4/02; H01M 4/525; H01M 10/0569

(52) U.S. Cl. CPC H01M 10/0568; H01M 4/525; H01M 10/0569; H01M 2004/028; H01M 2300/0028

(57) ABSTRACT

The present invention relates in a first aspect to a battery, typically a secondary cell battery which can be recharged, and in a second aspect to a an improved electrolyte, that is, a medium that comprises ions and that is charge conducting through the movement of those ions, rather than conducting through electrons, such as in the battery. The present invention provides and improved battery.

### FIELD OF THE INVENTION

The present invention relates in a first aspect to a battery, typically a secondary cell battery which can be recharged, and in a second aspect to a an improved electrolyte, that is, a medium that comprises ions and that is charge conducting through the movement of those ions, rather than conducting through electrons, such as in the battery. The present invention provides and improved battery.

### BACKGROUND OF THE INVENTION

The present invention is in the field of a secondary electrochemical cell, commonly referred to as a rechargeable battery. Such a cell is capable of generating electrical energy from (electro)chemical reactions or using electrical energy to cause (electro)chemical reactions, such as when recharged. The electrochemical cells which generate an electric current are called voltaic cells or galvanic cells and those that generate chemical reactions, via electrolysis for example, are called electrolytic cells. The present invention is focused on galvanic cells, such as a battery. A battery may consist of one or more cells. Cells can be connected in parallel, in series, or a combination thereof. When discharged/recharged such a cell effectively is both a galvanic cell and an electrolytic cell. It is used to store electric energy upon charging, and to deliver electric energy upon discharging.

A single valence ion battery, such as lithium-ion battery or sodium-ion battery, may be used for energy storage, which may be a type of rechargeable battery. These single valence ion batteries are widely used, such as for portable electronics, electric vehicles, and electrical energy storage devices. In the batteries, lithium ions may move back and forth, from the negative electrode to the positive electrode during discharge, and vice versa when charging. For rechargeable cells, the term cathode designates the electrode where reduction is taking place during the discharge cycle; for lithium-ion cells, the positive electrode is referred to as cathode, which typically is the lithium-based one. Li-ion batteries may use an intercalated lithium compound as one electrode material. The batteries have certain advantages over other electric energy storage devices, such as a relatively high energy density, low self-discharge, and no memory effect. Typical density characteristics are a specific energy density of up to 250 Wh/kg, a volumetric energy density of up to 700 Wh/l, and a specific power density of up to 1500 W/kg. Performance of the batteries can be improved, such as in terms of life extension, energy density, safety, costs, and charging speed.

There is an on-going need to improve a capacity, an energy density, prevent ion depletion, charging speed, and cycling performance of power supply units. In addition prior art devices tend to have too many inactive parts and/or too large inactive part. Some of these devices suffer from internal mechanical stress, capacity loss, and shortening of cycle life. In this respect Si could be considered as anode material, but it is often not suited in view of its large volumetric expansion when forming LiₓSi_{y}(such as Li_{4.4}Si).

Li-ion batteries usually consist of a LiCoO₂ cathode and graphite anode. During charging Li ions are transported towards and absorbed by the electrode, typically a graphite electrode, by intercalation of the Li ions in planar atomic graphite structure. The specific capacity of materials used in these batteries is in the order of 372 mAh/g (Ashuri et al., Nanoscale, vol. 8, 74 (2016)). It is typical to use one Li-ion or Na-ion salt, and sometimes to use two salts, of which one is than a dominant salt, with a higher concentration, typically LiPF6. Typically, a liquid Li-ion battery electrolyte further comprises at least two solvents, for example EC/DMC, and a few additives.

The electrolyte relates to a medium that comprises a solvent, such as water, and ions. A solvent is typically a fluid or solid substance that dissolves a solute, resulting in a solution. The quantity of solute that can dissolve in a specific volume of solvent may vary with temperature. The medium is electrically conducting, as the ions can more or less freely move through the solvent. The electrolyte typically is not conducting, such as conducting electrons. An electrolyte may relate to ions that are formed from soluble salts, acids, and bases, which are dissolved in the solvent, such as water. The solvent typically is polar, in view of the solubility of the ions involved. Upon dissolving, the substance separates into positively charged species, cations, and likewise negatively charged species, anions. These species are considered to distribute uniformly throughout the solvent, apart from a gradient formed by the electrodes of a battery and a movement of ions caused thereby. Solid-state electrolytes also exist, but these are not a primary objective here. Electrically, such a solution, in total, comprising the solvent and electrolytes, is substantially neutral, though an electrical gradient may exist. If an electric potential is applied to such a solution, as in a battery or the like, the cations of the solution are drawn to the electrode that has an abundance of electrons, while the anions are drawn to the electrode that has a deficit of electrons. The movement of anions and cations in opposite directions within the solution amounts to an electrical current. In science, electrolytes are one of the main components of electrochemical cells. So, when electrodes are placed in an electrolyte, and a voltage is applied to the electrodes or is obtained from the electrodes, the electrolyte will conduct charges. An electrochemical reaction will occur as a consequence, at the cathode, providing electrons to the electrolyte. Another electrochemical reaction will occur at the anode, consuming electrons from the electrolyte. As a result, a charge distribution, such as in the form of a negative charge cloud, which typically also has a gradient, forms in the electrolyte around the cathode, and likewise a positive charge forms around the anode. Without the ions from the electrolyte, the charges around the electrode would slow down continued electron flow; diffusion of charged species through the solvent to the other electrode is limited. In batteries, two materials with different electron affinities are used as electrodes; electrons flow from one electrode to the other outside of the battery, while inside the battery the circuit is closed by the electrolyte's ions. Here, the electrode reactions may convert chemical energy to electrical energy.

Any salt, and hence an electrolyte, has a limited solubility in a given solvent. Addition of further additives to the electrolytes, for other purposes typically, also may limit the solubility of the electrolytes themselves. The electrolytes typically also influence a cycle life of a battery, as well as conductivity of the electrolyte, operation temperature, and stability. The electrolytes are therefore in many aspects sub-optimal, and a as consequence the batteries comprising them also are. In addition, electrolyte degradation at the surface with the electrodes is one of the dominant causes for the end of life of Li-ion batteries. This is considered to relate to the specific decomposition products and the establishment of the so called Solid Electrolyte Interface (SEI), typically referring to an anode (whereas the cathodic electrolyte interface (CEI) likewise refers to the cathode).

Incidentally US 2022/140394 A1 recites electrolyte systems and/or separators for electrochemical cells that cycle lithium ions and which may have lithium metal electrodes. The electrochemical cell includes a liquid electrolyte system that fills voids and pores within the electrochemical cell. The electrolyte system includes two or more lithium salts and two or more solvents. The two or more lithium salts include bis(fluorosulfonyl)imide (LiN(FSO2)2) (LIFSI) and lithium perchlorate (LiClO4). The two or more solvents include a first solvent and a second solvent. The first solvent may be a fluorinated cyclic carbonate.

The second solvent may be a linear carbonate. A volumetric ratio of the first solvent to the second solvent may be 1:4. The electrochemical cell may include a surface-modified separator that has one or more coatings or fillers.

The present invention therefore relates to an improved power supply unit, in particular a battery, which solves one or more of the above problems and drawbacks of the prior art, providing reliable results, without jeopardizing functionality and advantages.

### SUMMARY OF THE INVENTION

It is an object of the invention to overcome one or more limitations of power supply units of the prior art and methods of making these and at the very least to provide an alternative thereto. The present invention provides and improved battery, such as in terms of battery cycle life, a more stable battery, and lower operational temperatures. By combining four or more single valence cation salts, also referred to as single valence salt, such as Li-salts, in electrolyte solvents inventors developed liquid electrolytes for single valence cation batteries that offer specific advantages compared to existing liquid electrolytes, which is considered to be largely based on the increased entropy of these systems. Specific advantages include: (1) Unexpectedly, the solubility of specific salts that are beneficial for battery cycle life can be increased; (2) A larger number of salts is found to change the interaction of the salts with the solvent, which enables to establish a more stable interface with electrodes, leading to a longer cycle life; (3) The cation conductivity is improved, and the solution is stabilized, enabling lower operation temperatures. (4) Also the single valence cation solvent interaction is weakened, as is established by Raman and NMR spectroscopy. In comparison to the single salt electrolytes, a low-concentration (0.6 molarity) dimethyl ether electrolyte with four-salts species shows an improved capacity retention of >80% over 600 cycles for nickel-rich cathodes charged to 4.3 V and improved power density. (5) The lifetime of electrodes is increased, in particular as less degradation thereof is observed. (6) The SEI, typically at both the anode and cathode, is improved, e.g. in terms of stability and single valence ion conductivity. Typically a lifetime of >1000 cycles is obtained, in particular >2000 cycles, such as >2500 cycles. Also a Coulomb Efficiency (CE) is >0.9995, in particular >0.9999. Also the power density or likewise the load speed is improved. It is noted that by combining more single valence cation salts a huge compositional space is provided, offering many possible compositions. The invention of combining four or more salts is found to increase the solubility of specific salts, that otherwise cannot be achieved. The present electrolyte creates a weaker solvation strength, which results in more inorganic SEI species, a higher cation conductivity, an improved low temperature operation, and a longer cycle life of single valence cation batteries. In a first aspect the present invention relates to a high entropy liquid electrolyte for a single valence cation battery, in particular a rechargeable battery, comprising at least one solvent, and at least 5 single valence salts dissolved in the at least one solvent, forming a liquid electrolyte, wherein each individual first salt is different from each individual second salt, wherein each salt individually comprises the same single valence cation, and for each salt an anion being different from the anions of the other of the at least 5 salts. Entropy is a scientific concept, as well as a measurable physical property, that is most commonly associated with a state of disorder, randomness, or uncertainty. The term and the concept are used in diverse fields, from classical thermodynamics, where it was first recognized, to the microscopic description of nature in statistical physics, and to the principles of information theory. It has found far-ranging applications in chemistry and physics, as in the present electrolyte. The present electrolyte is a liquid electrolyte, comprising the single valence salts, the at least one solvent, and optional further ingredients, such as salt additives, or solvent additives. The present single valence salts are at least partly soluble in the present at least one solvent, in particular well soluble, such as with concentrations >0.01 mole/l, in particular with concentrations >0.1 mole/l, such as >1 mole/l (all concentrations are taken at 25° C. and 100 kPa). The present electrolyte comprises the present single valence salts dissolved therein, typically dissolved for 75-100%, and therefore split in the single valence cation and the counter anion, which may be of single valence, or of a higher valence (e.g. 2-, 3-, 4-, 5-, 6-, etc.). Through formulating an electrolyte, typically having a regular salt concentration, however combining multiple (≥four, typically (≥five) commercially available lithium salts, the solvation interaction with the single valence cations is found to change fundamentally. In summary, introducing multiple commercial single valence cation salts in a conventional solvent is proposed as high entropy electrolytes, a novel class of liquid electrolytes. This is considered fundamentally differing from the common strategies to stabilize the SEI, for instance including the addition of film-forming additives and increasing the salt concentration. By means of increasing entropy, the thermodynamics of the electrolyte is changed, offering a new route to design interfacial chemistries in batteries, providing a huge chemical space to be explored, to support the development of high-performance batteries for practical application. It is demonstrated that high entropy electrolytes thus have large benefits.

In a second aspect the present invention relates to a single valence cation battery comprising the high entropy liquid electrolytes according to the invention.

In a third aspect the present invention relates to a system for power supply comprising at least one single valence cation battery according to the invention.

The present invention provides a solution to one or more of the above mentioned problems and overcomes drawbacks of the prior art.

Advantages of the present description are detailed throughout the description.

### DETAILED DESCRIPTION OF THE INVENTION

In an exemplary embodiment of the present high entropy liquid electrolyte for a single valence cation battery the cation is either Li⁺ or Na⁺.

In an exemplary embodiment of the present high entropy liquid electrolyte for a single valence cation battery the anion is selected from oxides, in particular from carboxylic acid residues, from weak acid residues, from sulphides, from sulfonyl compounds, from alkane compounds, from fluoro compounds, from phosphorous compounds, from imide compounds, from amide compounds, from borate compounds, from phosphate compounds, and from combinations thereof, in particular selected from NO₃⁻, bis(fluorosulfonyl)imide (FSI), bis(trifluoromethanesulfonyl)imide (TFSI), difluoro(oxalate) borate (DFOB), tetrafluoroborate (BF₄), from bis(trifluoromethanesulfonyl)imide, trifluoromethanesulfonate, trifluoroacetate, acetylacetonate, AsF_{6,} and hexafluorophosphate (PF₆). Exemplary salts are amongst others Lithium Perchlorate (LiClO₄), Lithium Hexafluoroarsenate (LiAsF₆), Lithium Tetrafluoroborate (LiBF₄), Lithium nitrate (LiNO₃), Lithium Trifluoromethanesulfonate (LiOTF), Lithium Hexafluorophosphate (LiPF₆), lithium trifluoromethanesulfonate (LiCF₃SO₃), lithium nonafluorobutanesulfonate (LiC₄F, SO₃), Lithium bis(fluorosulfonyl)imide (LiFSI), Lithium bis(trifluoromethanesulfonyl)imide (LiTFSI), Lithium bis(pentafluoroethanesulfonyl)imide (LiBETI), Lithium difluoro(oxalato)borate (LiDFOB), Lithium bis(oxalato)borate (LiBOB), Lithium difluoro(bisoxalato) phosphate (LiDFBOP), lithium dicyanamide (LiN(CN)₂), LiBF_{4-X}R_{X} (X=0-4, R is an fluoroalkyl group and fluorosulfonic group having 1 to 3 carbon atoms), Lithium phosphorodifluoridate (LiPO₂F₂), LiF, LiCl, LiBr, LiI, Li₂O, Li₂CO₃, Li₃PO₄, Li₂SO₄, Sodium Perchlorate (NaClO₄), Sodium Hexafluoroarsenate (NaAsF₆), Sodium Tetrafluoroborate (NaBF₄), Sodium nitrate (NaNO₃), Sodium Trifluoromethanesulfonate (NaOTF), Sodium Hexafluorophosphate (NaPF₆), Sodium trifluoromethanesulfonate (NaCF₃SO₃), Sodium nonafluorobutanesulfonate (NaC₄F₉SO₃), Sodium bis(fluorosulfonyl)imide (NaFSI), Sodium bis(trifluoromethanesulfonyl)imide (NaTFSI), Sodium bis(pentafluoroethanesulfonyl)imide (NaBETI), Sodium difluoro(oxalato)borate (NaDFOB), Sodium bis(oxalato)borate (NaBOB), Sodium difluoro(bisoxalato) phosphate (NaDFBOP), Sodium dicyanamide (NaN(CN)₂), NaBF_{4-X}R_{X} (X=0-4, R is an fluoroalkyl group and fluorosulfonic group having 1 to 3 carbon atoms), Sodium phosphorodifluoridate (NaPO₂F₂), NaF, NaCl, NaBr, NaI, Na₂O, Na₂CO₃, Na₃PO₄, and Na₂SO₄.

In an exemplary embodiment of the present high entropy liquid electrolyte for a single valence cation battery the at least one solvent is selected from carbonates, in particular linear carbonates, such as ethyl methyl carbonate (EMC), and di-ethyl carbonate (DEC), from carboxylates, in particular from carboxylates with different chain lengths, such as methyl acetate (MA), and ethyl acetate (EA), from ethers, such as dimethyl ether (DME), and 1,3 dioxolane (DOL), from esters, from nitriles, such as acetonitrile (AN), proprionitrile (PN), and butyronitrile (BN), water, from alcohols, such as ethanol, from sulfones, such as ethylmethyl sulfone (EMS), and trimethylsulfone (TMS), from sulfoxides, from sulphites, from anhydrides, from fluorinated solvents, such as fluorinated ethylene carbonate (FEC), and fluorinated methyl ethyl carbonate (FEMC), from ketones, from ionic liquids, from nitriles, from silicates, and from aldehydes, and in particular combinations thereof. Examples of solvents are Ethylene Carbonate (EC), Diethyl Carbonate (DEC), Dimethyl Carbonate (DMC), Ethyl Methyl Carbonate (EMC), Propylene Carbonate (PC), Methyl Propyl Carbonate (MPC), Butylene Carbonate (BC), Dipropyl Carbonate (DPC), Ethyl Propyl Carbonate (EPC), Vinylene Carbonate (VC), Methyl Formate (MF), Methyl Acetate (MA), 1,4-Butyrolactone (BL), Methyl Butyrate (MB), Ethyl Propionate (EP), Vinyl Ethylene Carbonate (VEC), 1,3,2-dioxathiolane-2,2-dioxide (DTD), Fluoroethylene Carbonate (FEC), Fluorodiethyl Carbonate (FDEC), Fluorodimethyl Carbonate (FDMC), Fluoroethyl Methyl Carbonate (FEMC), Fluoropropylene Carbonate (FPC), Fluoromethyl Propyl Carbonate (FMPC), Fluorobutylene Carbonate (FBC), Fluorodipropyl Carbonate (FDPC), Fluoroethyl Propyl Carbonate (FEPC), Fluorovinylene Carbonate (FVC), Fluoromethyl Formate (FMF), Fluoromethyl Acetate (FMA), Fluoro-1,4-Butyrolactone (FBL), Fluoromethyl Butyrate (FMB), Fluoroethyl Propionate (FEP), Fluorinated Vinyl Ethylene Carbonate (FVEC), Dimethyl ether (DME), Diethyl ether (DEE), Dipropyl ether (DPE), Methyl ethyl ether (MEE), Methyl propyl ether (MPE), Diethylene glycol dimethyl ether (DEGDME), Tetraethylene glycol di-methyl ether (TEGDME), Tetrahydrofuran (THF), Dioxolane (DOL), Fluorinated Dimethyl ether (FDME), Fluorinated Diethyl ether (FDEE), Fluorinated Dipropyl ether (FDPE), Fluorinated Methyl ethyl ether (FMEE), Fluorinated Methyl propyl ether (FMPE), Fluorinated Diethylene glycol dimethyl ether (FDEGDME), Fluorinated Tetraethylene glycol dimethyl ether (FTEGDME), Fluorinated Tetrahydrofuran (FTHF), Fluorinated Dioxolane (FDOL), Dimethyl sulfone (DMS), Ethyl methyl sulfone (EMS), Tetramethylene sulfone (TMS), Ethylene sulfite(ES), propyl sulfone (PS), Propylmethyl sulfone (PMS), Isopropyl sulfone (IS), Dimethyl sulfoxide (DMSO), Methylsulfonylmethane (MSM), Sulfolane (SL), Phenyl trifluoromethyl sulfide (PTS), Fluorinated Dimethyl sulfone (FDMS), Fluorinated Ethyl methyl sulfone (FEMS), Fluorinated Tetramethylene sulfone (FTMS), Fluorinated Dimethyl sulfoxide (FDMSO), Fluorinated Methylsulfonylmethane (FMSM), Fluorinated Sulfolane (FSL), Fluorinated sulfone 3,3,3-trifluoropropylmethyl sulfone (FPMS), Trifluoromethyl ethyl sulfone (FMES), Trilfuoromethyl propyl sulfone (FMPS), Trifluoromethanesulfonic anhydride (TFMSA), Trifluoromethyl isopropyl sulfone (FMIS), Fluorinated Phenyl trifluoromethyl sulfide (FPTS), Triethyl phosphate (TEP), Trimethyl phosphate (TMP), Dimethyl methyl phosphate (DMMP), Diethyl ethylphosphonate (DEEP), Tripropargyl phosphate (TPP), Ethylene ethyl phosphate (EEP), Triamyl phosphate (TAP), Tributyl phosphate (TBP), Fluorinated Triethyl phosphate (FTEP), Fluorinated Trimethyl phosphate (FTMP), Fluorinated Dimethyl methyl phosphate (FDMMP), Fluorinated Diethyl ethylphosphonate (FDEEP), Fluorinated Tripropargyl phosphate (FTPP), Fluorinated Ethylene ethyl phosphate (FEEP), Fluorinated Triamyl phosphate (FTAP), Fluorinated Tributyl phosphate (FTBP), Alkylmethylimidazolium, Alkylmethylpyrrolidinium, Ammonium (ether functionalized), Ammonium Phosphonium, Spirocyclic ammonium, Anions group commonly used in ionic liquids: [FSI]⁻, [TFSI]⁻, [DCA]⁻, [PF₆]⁻, [BF₄]⁻, [NO₃]⁻, Hydrofluoroethers (HFEs), 1,1,2,2-tetrafluoroethyl-2,2,3,3-tetrafluoropropyl ether (TTE), bis(2,2,2-trifluoroethyl) ether (BTFE), Tris(pentafluorophenyl)phosphine (TPFP), Tris(2,2,2-trifluoroethyl)phosphate (TTFEP), Acetonitrile (AN), Propionitrile (PN), 1,5-dicyano pentane (DCP), Adiponitrile (ADN), Triethoxy(octyl)silane (TEOS), and Tetraethyl orthosilicate (TEtOS).

In an exemplary embodiment of the present high entropy liquid electrolyte for a single valence cation battery the concentration of each individual single valence salt is 0.01-5 mole/l, in particular 0.05-4 mole/l, more in particular 0.1-2.4 mole/l, even more in particular 0.2-1.5 mole/l.

In an exemplary embodiment of the present high entropy liquid electrolyte for a single valence cation battery at least one first single valence salt of the at least four single valence salts is present in a concentration of 0.1-2.5 mole/l, in particular 0.4-1.5 mole/l.

In an exemplary embodiment of the present high entropy liquid electrolyte for a single valence cation battery at least one second single valence salt of the at least four single valence salts is present in a concentration of <50% of the concentration of the at least one first single valence salt, in particular <25% of the concentration of the at least one first single valence salt, more in particular <10% of the concentration of the at least one first single valence salt.

In an exemplary embodiment of the present high entropy liquid electrolyte for a single valence cation battery at least one third single valence salt of the at least four single valence salts is present in a concentration of <50% of the concentration of the at least one first single valence salt, in particular <25% of the concentration of the at least one first single valence salt, more in particular <10% of the concentration of the at least one first single valence salt.

In an exemplary embodiment of the present high entropy liquid electrolyte for a single valence cation battery at least one fourth single valence salt of the at least four single valence salts is present in a concentration of <50% of the concentration of the at least one first single valence salt, in particular <25% of the concentration of the at least one first single valence salt, more in particular <10% of the concentration of the at least one first single valence salt. Examples are: LiFSI/0.1 M LiNO3/1.0 M LiPF6, 0.1 M LiTFSI/0.1 M LiNO3/1.0 M LiPF6, 0.1 M LiDFOB/0.1 M LiNO3/1.0 M LiPF6, and 0.1 M LiFSI/0.1 M LiTFSI/0.1 M LiDFOB/0.1 M LiNO3/1.0 M LiPF6 (1.4 M HE).

In an exemplary embodiment of the present high entropy liquid electrolyte for a single valence cation battery a total concentration of the at least four salts is 0.1-10 mole/l, in particular 0.2.2-5 mole/l, more in particular 0.5-2.5 mole/l. These concentrations are also referred to as medium range concentrations, in view of the field of application.

In an exemplary embodiment the present high entropy liquid electrolyte for a single valence cation battery comprises 5-12 salts dissolved in the at least one solvent, in particular 6-9 salts, more in particular 7-8 salts.

In an exemplary embodiment of the present high entropy liquid electrolyte for a single valence cation battery at least one fifth single valence salt of the at least four single valence salts is present in a concentration of <50% of the concentration of the at least one first single valence salt, in particular <25% of the concentration of the at least one first single valence salt, more in particular <10% of the concentration of the at least one first single valence salt.

In an exemplary embodiment of the present high entropy liquid electrolyte for a single valence cation battery at least one sixth single valence salt of the at least four single valence salts is present in a concentration of <50% of the concentration of the at least one first single valence salt, in particular <25% of the concentration of the at least one first single valence salt, more in particular <10% of the concentration of the at least one first single valence salt.

In an exemplary embodiment of the present high entropy liquid electrolyte for a single valence cation battery at least one seventh single valence salt of the at least four single valence salts is present in a concentration of <50% of the concentration of the at least one first single valence salt, in particular <25% of the concentration of the at least one first single valence salt, more in particular <10% of the concentration of the at least one first single valence salt.

In an exemplary embodiment of the present high entropy liquid electrolyte for a single valence cation battery at least one eight single valence salt of the at least four single valence salts is present in a concentration of <50% of the concentration of the at least one first single valence salt, in particular <25% of the concentration of the at least one first single valence salt, more in particular <10% of the concentration of the at least one first single valence salt.

In an exemplary embodiment of the present high entropy liquid electrolyte for a single valence cation battery at least one optional further single valence salt of the at least four single valence salts is present in a concentration of <50% of the concentration of the at least one first single valence salt, in particular <25% of the concentration of the at least one first single valence salt, more in particular <10% of the concentration of the at least one first single valence salt.

In an exemplary embodiment of the present high entropy liquid electrolyte for a single valence cation battery the electrolyte comprises >0.05 M of a low soluble salt, wherein the low soluble salt is selected from LiNO₃, Lithium difluoro(oxalato)borate (LiDFOB), and combinations thereof. Surprisingly, low soluble salts, with a solubility in the present at least one solvent of <0.01 mole/l, are now reasonably soluble, typically >0.1 mole/l, such as >0.2mole/l.

In an exemplary embodiment of the present high entropy liquid electrolyte for a single valence cation battery the at least one solvent comprises a compound selected from poly ethylene carbonate, ethylmethyl carbonate, di-ethyl carbonate, methyl acetate, ethyl acetate, di-methyl ether, 1,3-dioxolane, acetonitrile, propionitrile, butyronitrile, and combinations thereof, in particular >50% of such a compound, more in particular >75% of such a compound, wherein the % is taken based on the total volume of the at least one solvent. Surprisingly the present at least one solvent can now be selected from compounds that are otherwise considered to be detrimental to at least one of the electrodes, such as for graphite. Examples of such compounds relate to poly ethylene carbonate.

In an exemplary embodiment the present single valence cation battery further comprises at least one electrode, in particular at least one anode and at least one cathode, and an electrolyte compartment provided in fluidic contact with the at least one electrode.

In an exemplary embodiment of the present single valence cation battery the material of the cathode is selected from Fe comprising cathodes, from Mn comprising cathodes, from Li or Na comprising cathodes, from Co comprising cathodes, from transition metal alloys, from Ni comprising cathodes, in particular from nickel comprising alloys, more in particular from nickel alloys with >75% Ni, such as >80 atom % Ni.

In an exemplary embodiment of the present single valence cation battery the anode comprises a material selected from alloys, in particular from Al-alloys, from Sn-alloys, from Mg-alloys, from Ag-alloys, from Sb alloys, and from silicon alloys (a-Si_{y}Aₓ:Q_{z}), wherein element A is selected from B, C, N, Ge, O, and combinations thereof, wherein element Q is selected from H, F, and combinations thereof, and from silicon, wherein the silicon alloy or silicon is porous for accommodating electrolyte ions, such as Li ions, wherein the silicon alloy or silicon has a porosity from 1-50%, wherein the silicon alloy or silicon is amorphous, and wherein the silicon or silicon alloy is preferably hydrogenated, from conversion-type anode materials, in particular from metal sulphides, metal oxides, metal phosphides, metal nitrides, metal fluorides, and metal selenides, more in particular wherein the metal thereof is a transition metal, from carbon based compounds, such as graphite, and graphene, and from a Li- or Na-metal anode.

The invention will hereafter be further elucidated through the following examples which are exemplary and explanatory of nature and are not intended to be considered limiting of the invention. To the person skilled in the art it may be clear that many variants, being obvious or not, may be conceivable falling within the scope of protection, defined by the present claims.

### SUMMARY OF THE FIGURES

FIGS. 1a-g, 2a-e, 3a-f, 4a-d, 5a-I, and 6-8 show experimental results of the present invention.

### FIGURES

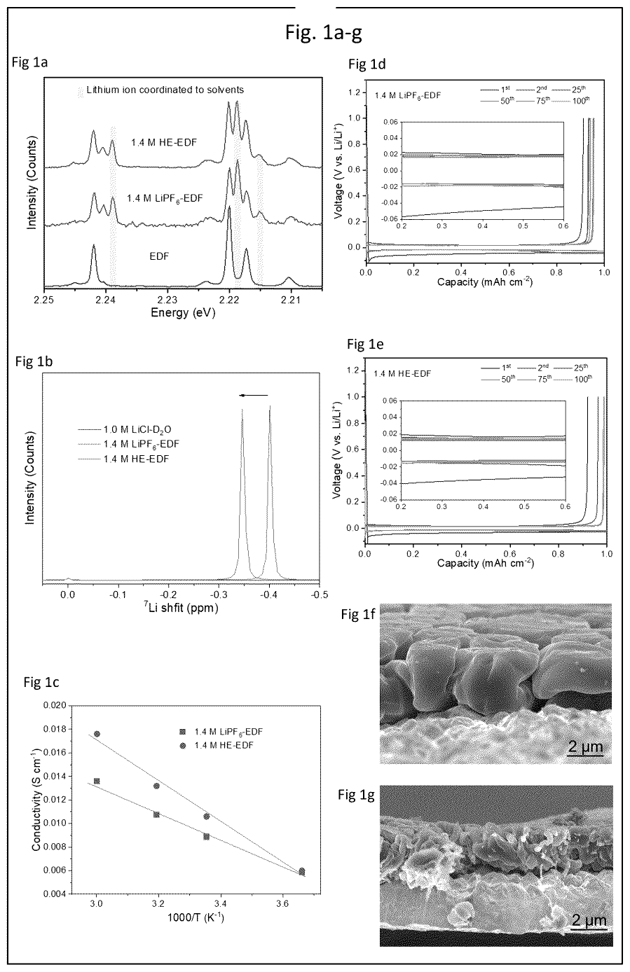

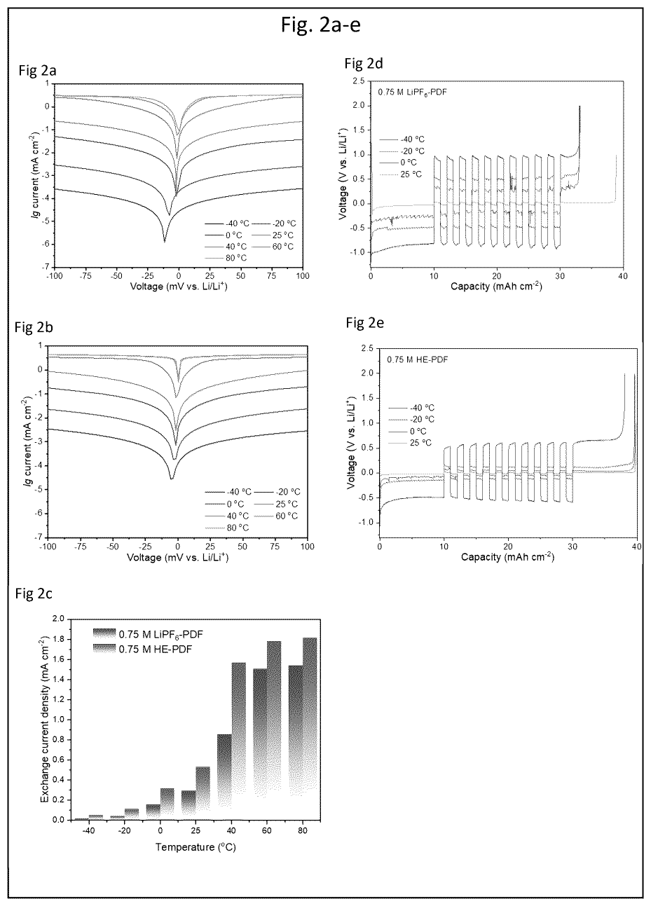

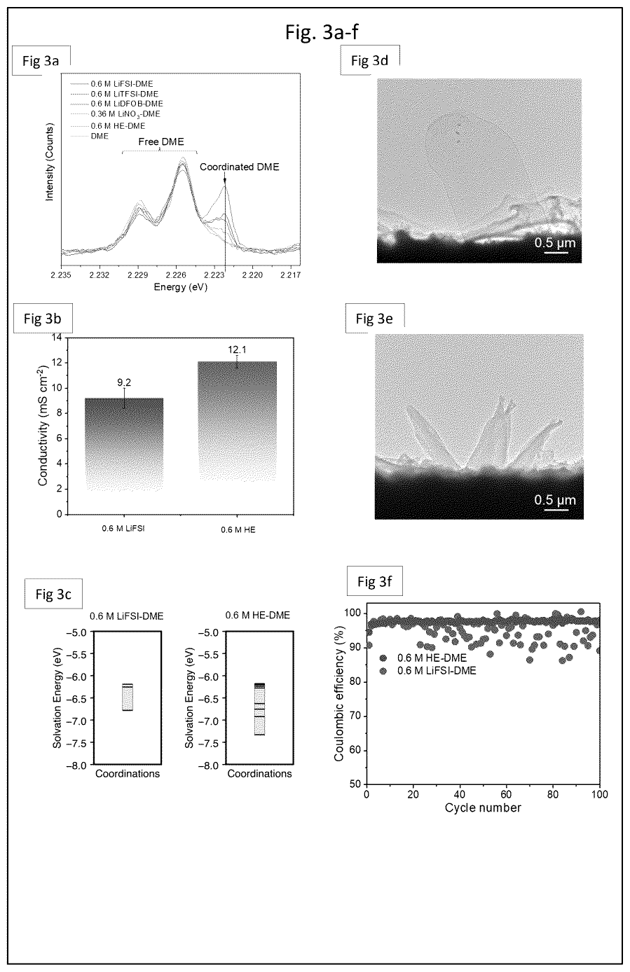

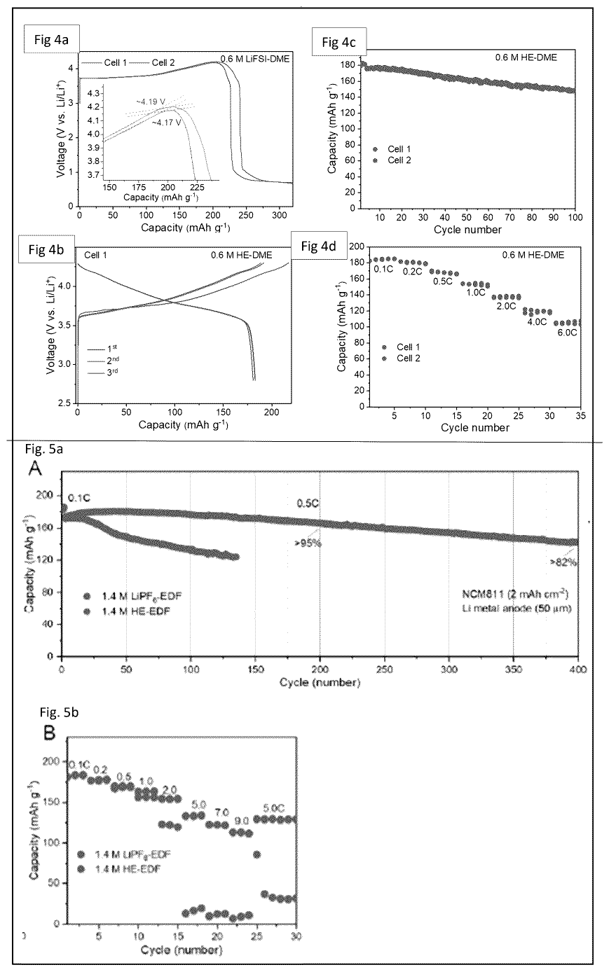

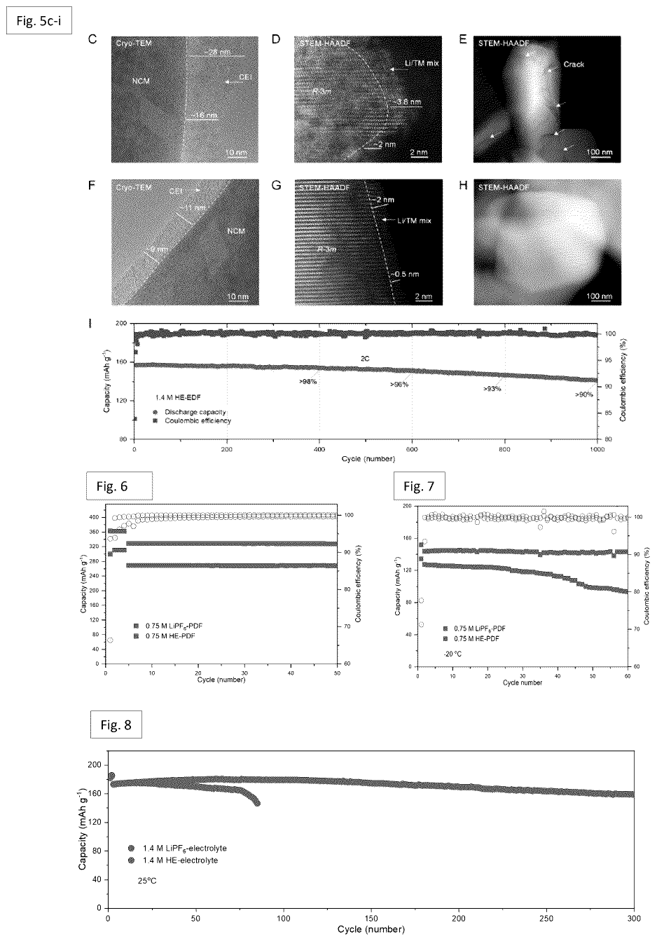

FIG. 1 Characterization of the lithium-ion solvation structure and compatibility with lithium metal anodes. (A) Raman spectra of the (1 Molair LiPOF6 in EC/DMC (1:1 by weight), 5% FEC) (EDF) solvent, 1.4 M LiPF₆-EDF, and 1.4 M HE-EDF. (B) Liquid ⁷Li nuclear magnetic resonance (NMR) spectra of 1.4 M LiPF₆-EDF and 1.4 M HE-EDF electrolyte. (C) Lithium ionic conductivity of the 1.4 M LiPF₆-EDF and 1.4 M HE-EDF electrolyte at various temperatures. (D and E) Galvanostatic lithium plating/stripping profiles of Li∥Cu cells cycled in (D) 1.4 M LiPF₆-EDF, (E) 1.4 M HE-EDF electrolyte of selected cycles at 0.5 mA cm⁻² and 1 mAh cm⁻². The inserts show the zoomed-in voltage curves of selected cycles. (F and G) Cross-section SEM images of lithium first cycle plating using (F) 1.4 M HE-EDF and (G) 1.4 M LiPF₆-EDF electrolytes in Li∥Cu cells at 0.5 mA cm⁻² to 1.0 mAh cm⁻².

FIG. 2 Low-temperature performance of the HE electrolyte. (A and B) Tafel plots of (E) 0.75 M LiPF₆-PDF and (F) 0.75 M HE-PDF electrolytes at different temperatures. (C) Lithium ionic conductivity of the 0.75 M LiPF₆-PDF and 0.75 M HE-PDF electrolytes at various temperatures. (D and E) Aurbach measurement of lithium metal CE in Li∥Cu cells using (D) 0.75 M LiPF₆-PDF or (E) 0.75 M HE-PDF electrolyte under different temperatures.

FIG. 3 Lithium-ion solvation structure and compatibility with lithium metal anodes. (A), ⁷Li NMR spectra of single-salt electrolytes and the as-prepared HE electrolyte. Due to the relatively low salt solubility of LiNO₃ in DME, a 0.36 M LiNO₃-DME electrolyte was prepared for comparison. (B), Comparison of the lithium-ion conductivity of the HE-DME electrolyte and the single salt electrolytes. (C) Solvation structure from Raman spectra of 0.6 M HE-DME electrolyte and 0.6 M LiFSI-DME, 0.6 M LiTFSI-DME, 0.6 M LiDFOB-DME and 0.36 M LiNO₃-DME electrolytes. (D and E), Microstructure of deposited lithium metal from Cryo-TEM images recorded from different sites using the (D) 0.6 M HE-DME electrolyte the (E) 0.6 M LiFSI-DME electrolyte. (F), Lithium plating/stripping Coulombic efficiency (CE) in Li∥Cu cells using 0.6 M LiFSI and 0.6 M HE-DME electrolytes. Lithium was electrodeposited at 0.5 mA cm⁻² to a total capacity of 1 mAh cm⁻².

FIG. 4 Electrochemical performance of the 0.6 M LiFSI and 0.6 M HE-DME electrolytes used in LiNi_{0.8}Co_{0.1}Mn_{0.1}O₂ (NCM811) cells. (A and B) Galvanostatic charge/discharge curves of Li∥NCM811 cells in (A) 0.6 M LiFSI-DME and (B) 0.6 M HE-DME electrolytes in the voltage range of 2.8-4.3 V at a rate of C/10(1C=180 mA g⁻¹). (C) Cycling performance of Li∥NCM811 cells with a 0.6 M HE-DME electrolyte cycled between 2.8 and 4.3 V at a C/10 rate for three cycles before cycling at a C/3rate. (D) Electrochemical rate capability of Li∥NMC811 cells cycled between 2.8 and 4.3 V with a 0.6 M HE-DME electrolyte.

FIG. 5. Electrochemical performance and cathode interphase stability of the HE electrolyte. a, Capacity retention of Li∥NCM811 cells with 1.4 M LiPF₆-EDF or 1.4 M HE-EDF electrolytes cycled between 2.8-4.3 V with 0.1C (1C=180 mA g⁻¹) for three cycles and 0.5C for the following cycles. The areal capacity of NCM811 electrode is 2 mAh cm⁻² and the lithium metal anode is 50 μm. b, Rate performance of Li∥NMC811 cells cycled between 2.8-4.3 V under various current densities in different electrolytes, showing improved power density and quicker charging. c, f, Cryo-TEM images of NCM811 cathode electrolyte inter-phase (CEI) after cycling in (c) 1.4 M LiPF₆-EDF and (f) 1.4 M HE-EDF electrolytes. d, g, High resolution STEM-HAADF images of NCM811 cathode after cycling in (d) 1.4 M LiPF₆-EDF, and (g) 1.4 M HE-EDF electrolytes. e, h, Low-magnification STEM-HAADF images of primary NCM811 particle morphology after cycling in (e) 1.4 M LiPF₆-EDF and (h) 1.4 M HE-EDF electrolytes. i, Capacity retention of graphite∥NCM811 cells with the 1.4 M HE-EDF electrolyte cycled between 3.0-4.2 V at 0.1C rate for first three cycles and 2.0C for following cycles. The capacity ratio of the negative over the positive electrode is in the range of 1.05~1.10.

FIG. 6. Cycling performance of Li∥Graphite cells with 0.75 M LiPF₆-PDF or 0.75 M HE-PDF electrolyte at a C/10 rate for four cycles before cycling at a C/2 rate.

FIG. 7. Cycling performance of Li∥NCM811 cells with 0.75 M LiPF₆-PDF and 0.75 M HE-PDF electrolytes cycled between 2.8 and 4.3 V at a C/10 rate for one cycle before cycling at a C/2 rate under −20° C.

FIG. 8. Cycling performance of Li∥NCM811 cells with 0.75 M LiPF₆-PDF or 0.75 M HE-PDF electrolyte cycled between 2.8 and 4.3 V at a C/10 rate for two cycles before cycling at a C/2 rate under 25° C.

FIG. 6 shows a C/2, at 30 minutes cycling, that the present electrolyte performs much better, with an improved conductivity, a lower internal resistance, quicker charging, and higher power density. FIG. 7-8 show that also at lower concentrations de HE performs better, e.g., a higher capacity and lower resistance, a higher Coulomb Efficiency, and a longer lifetime.

### EXPERIMENTS

A commercial 1.0 M LiPF₆ in EC/DMC carbonate electrolyte (1:1 by weight) with 5% fluoroethylene carbonate (FEC) is selected as baseline electrolyte, which has negligible solubility for LiNO3 (≤1000 ppm). The commercially available salts LiFSI, LiTFSI and LiDFOB are introduced based on their relative innocuousness and good solubility in carbonates, and combined to raise the entropy of the electrolyte. The presence of these multiple salt components increases the solubility of LiNO₃ up to 0.1 M, leading to the obtained HE electrolyte composition of 0.1 M LiFSI/0.1 M LiTFSI/0.1 M LiDFOB/0.1 M LiNO₃/1.0 M LiPF₆ in EC/DMC (1:1 by weight) with 5% FEC, henceforth referred to as 1.4 M HE-EDF.

None of the individual salt is able to promote LiNO₃ dissolution as insoluble LiNO₃ is clearly observed, and thus the combination of multiple salts is held responsible for the increased LiNO₃ solubility. The same strategy is further examined in an ether-based system, also resulting in a significant improvement of the LiNO₃ solubility by raising the entropy of mixing through introducing multiple salts. In the HE electrolyte, the larger variety of solvation interactions are anticipated to be responsible for the larger entropy of mixing, thereby decreasing the Gibbs Free energy and thus increasing the solubility. In addition, this can be expected to influence the temperature-dependent properties of the electrolytes due to its diverse solvation structure. The pure EC solvent that is solid at room temperature (melting point ~36.4 ° C., is mixed with each single salt as well as with the combination of multiple salts to form a HE system. After preparation at 60° C., all electrolytes are clear, representing uniform solutions. However, during cooling to room temperature, the electrolytes with the single extra salt turn into semi-solid or solid, except for the HE electrolyte, which maintains liquid for a longer period of several hours. This suggests that raising the entropy can also be an effective strategy to improve the electrolyte properties for lower temperature applications as was also suggested for introducing specific solvents, in which case however the melting point of the solvents plays a dominant role.

Raman spectroscopy demonstrates that the 1.4 M HE-EDF electrolyte has a weaker solvation interaction between the lithium-ions and EDF solvents, as compared to the single-salt 1.4 M LiPF₆-EDF electrolyte and the other control electrolytes, reflected by the weaker coordinated peak. Consistently, a downfield shift in the ⁷Li NMR spectra is observed for the 1.4 M HE-EDF electrolyte, indicating weaker interactions of lithium ions with both solvents and anion groups. A higher conductivity is achieved in the 1.4 M HE-EDF compared with the control electrolytes. Molecular dynamics (MD) simulations indicate that the various anion species in 1.4 M HE-EDF electrolyte result in a rich diversity of more than 100 types of lithium-ion solvation environments, much more than what is obtained for the 1.4 M LiPF₆-EDF electrolyte. The simulated self-diffusion coefficient of the 1.4 M HE-EDF electrolyte (1.9×10⁻⁶ cm² s⁻¹) is larger than that of the 1.4 M LiPF₆-EDF electrolyte (1.2×10⁻⁶ cm² s⁻¹), in agreement with the measured improvement in the conductivity. The higher lithium-ion mobility in the 1.4 M HE-EDF electrolyte is also con-firmed by the larger lithium transference number, and higher exchange current density.

The SEI composition and structures are also different, being inorganic dominated for the 1.4 M HE-EDF electrolyte, implying that more anion groups participate in the SEI formation. Inorganic Li—F, Li—N, B—F, Li—O and B—O species dominate the SEI in the 1.4 M HE-EDF electrolyte. The presence of these species suggests a more facile and homogeneous lithium-ion supply, supporting dense lithium metal growth. This explains the better reversibility of the lithium metal anode in 1.4 M HE-EDF. Despite the presence of multiple salts, the 1.4 M HE-EDF electrolyte does not show aluminium foil corrosion, as demonstrated by a stable anodic current at a polarization potential of 4.2 V vs. Li/Li+ for 20 h.

It is found that introducing multiple salts to form the HE composition lowers the freezing point, improving the low-temperature electrolyte properties.

The solvation structure of the HE electrolyte is studied at different temperatures using variable-temperature (VT) ⁷Li NMR experiments. As temperature decreases, the ⁷Li resonance of the 0.75 M HE-PDF shows a smaller shift compared to the 0.75 M LiPF₆-PDF electrolyte, which demonstrates that introducing multiple salts stabilizes the solution when the temperature changes. The downfield shift of 0.75M HE-PDF compared to 0.75 M LiPF₆-PDF at each temperature indicates a weaker solvation strength for the HE electrolyte, that can be expected to promote the lithium-ion kinetics.

Li∥Li symmetric cells were used to evaluate the overall ionic transport, especially under low temperatures. The Tafel plot at different temperature are measured and the higher exchange current density in 0.75M HE-PDF confirms the improved kinetics by increasing entropy. A higher conductivity can be achieved in 0.75M HE-PDF under variable temperatures from −40° C. to 100° C. compared with 0.75 M LiPF₆ PDF. The lithium transference number are measured at room temperature, giving 0.573 for 0.75M HE-PDF and 0.465 for 0.75 M LiPF₆ PDF, respectively. These properties are held responsible for the improved electrochemical performance reflected by the lower overpotential and higher average CE at different temperatures.

A prototype HE electrolyte was prepared by combining 0.15 mol/L (M) lithium bis(fluorosulfonyl)imide (LiFSI), 0.15 M lithium bis(trifluoromethanesulfonyl)imide (LiTFSI), 0.15 M lithium difluoro(oxalato)borate (LiDFOB) and 0.15 M lithium nitrate (LiNO₃) in dimethoxyethane (DME) as solvent, forming a 0.6 M HE-DME electrolyte. The present electrolyte provides a better anode compatibility and a better cathode compatibility, compared to a single salt (0.6 M LiFSI-DME, best example thereof).

In an example specifically containing 0.15 M LiPF₆/0.15 M LiTFSI/0.15 M LiFSI/0.15 M LiDFOB/0.15 M LiNO₃ is used [further examples are given below]. A weaker solvation interaction, and an anion rich solvation sheath is obtained, despite the relatively low total salt concentration, such as for a 0.6 M DME electrolyte. The result is a conformal, inorganic rich solid-electrolyte interphase (SEI) that effectively passivates the surface, and improve the reversibility of the electrode. Further solvent co-intercalation is prevented, resulting in high cycling stability and rate performances, and to increase the energy density. With the disordered solvation electrolyte, in an example, a typical high-energy NCM811∥Graphite full cells deliver 600 cycles with a capacity retention of ~94.0%. Moving towards higher energy density, the NCM811∥Si/Graphite (450 mAh g⁻¹) cell achieve an initial Coulombic efficiency (CE) of 86.3% and show capacity retention of ~94.5% after 300 cycles. Furthermore, the higher energy NCM811∥Si/Graphite (1000 mAh g⁻¹) shows stable cycling with an average CE around 99.9% and a capacity retention of ~90.0% after 300 cycles.

In a further experiment cells with the SDE containing five salts are highly reversible, displaying voltage plateaus between 0.001-0.25 V representing the different stages of Li-graphite intercalation. In this case the initial CE of exceeds 90%, and at subsequent cycling at 0.3C rate 99% capacity is maintained. This improved cycling stability can be ascribed to a protective SEI formed during the initial stages of the first discharge, indicated by a large peak in the dQ/dV. Since salt decomposition takes place around ~1.5 V, whereas the decomposition of cyclic carbonate solvents occurs around 0.6 V, the SEI formation is turned out to be dominated by salt decomposition. This is also supported by the redox peaks in cyclic voltammetry (CV) measurements, suggesting a salt-dominated solvation structure. In the subsequent cycles, this peak disappears, indicating that the SEI formed in the SDE can effectively suppress further electrolyte decomposition and support reversible Li⁺ intercalation into graphite. Furthermore, this stable SEI and disordered solvation structure also enable improved rate performances even when compared to the commercial EC/DMC electrolyte with the SDE a much higher CE, exceeding 95.0 %, is obtained, and more stable cycling as well as better high-rate capacity retention are achieved. Finally, an anode with a higher fraction of Si having a specific capacity of 1000 mAh g⁻¹ (Si/G1000) shows good performance, demonstrating an initial CE of above 88.5% and good cycling and rate performance in combination with the SDE electrolyte. the better structural integrity of the electrode surface is observed compared with the CCE, without graphite exfoliation after discharge; highlighting the ability of the stable SEI in the SDE to effectively passivate the graphite surface during the initial cycle.

The atomic composition in the SDE-derived SEI shows lower C, O content and higher F content as well as N, B, and S, species that originate from salt decomposition. This implies that the SEI formed in SDE has more anion-derived interfacial chemistry. Even though the C and O content of the SEI in the CCE slightly decreases in depth, indicating incomplete reduction of the solvent, the average content is larger than that in the SDE, which can be held responsible for the abundance of organic components in SEI. The peak intensities of C—O and C═O in the SDE-derived SEI is lower than that in the CCE, confirming the more inorganic-rich SEI due to the anion-dominated solvation structure. The compact SEI dominated by inorganic components, which de-rived from the disordered solvation structure in the SDE, is held responsible for passivating, and thereby stabilizing the graphite surface. Compared to the CCE electrolyte, the SDE electrolyte shows much better electrochemical compatibility with lithium metal, as indicated with the reversible plating/stripping over 200 cycles with the average CE that exceeds 99.0%.

The Raman spectra are collected for both electrolytes and the pure PC solvent. The peaks at 2.242 eV and 2.238 eV can be attributed to free PC molecules and solvating PC molecules, respectively. With the increase of disorder, the relative contribution of free PC molecules increases and that of solvated PC molecules decreases, indicating decreased interaction between the solvent and the Li⁺ in the SDE. ⁷Li liquid NMR spectroscopy was performed to study the solvation strength, where the chemical shift reflects the shielding of Li⁺ as a result of their solvation environment. An up-field shift was observed for CCE, indicating more shielded Li⁺ due to the high electron density from the stronger solvation interaction with both solvent and anion. Oppositely, a downfield chemical shift (~0.12 ppm) is observed for the SDE, which implies lower shielding, and thus a decreased interaction between solvation sheath and Li⁺. The ΔGₛₒₗᵥₐₜᵢₒₙ is further investigated, which represents an overall evaluation of the binding strength between Li⁺ and solvating species (both solvent and anion). The more positive ΔGₛₒₗᵥₐₜᵢₒₙ in SDE suggests a weaker solvation interaction (thus lower Li⁺-anion dissociation energy) of this proposed SDE. Therefore, with less coordinated solvent and decreased solvation sheath interaction, the solvation structure in SDE is more similar to the aforementioned salt dominated solvation model.

Altogether, these findings indicate that solvation disorder, induced by introduction of multiple salts in the PC solvent, can lead to a more diverse solvation environment and a weaker Li⁺-solvent coordination, that can be used to improve the interface chemistries. This is conceptually similar to high entropy alloys or materials, where the presence of multiple principal elements stabilizes solid solution phases through increasing the configurational disorder. Note that introducing multiple salts, while keeping the overall salt concentration the same, differs from adding extra additives/co-solvents or increasing the salt concentration, which are commonly applied strategies to influence the SEI formation. Here we propose that the Li⁺-solvent interaction can be decreased through disorder, leading to a salt dominated solvation structure, which should result in a salt de-rived, robust SEI. Another potential asset is that a disordered solvation structure can be expected to pose smaller barriers for Li⁺ de-solvation, which may also suppress solvent co-intercalation in graphite electrodes. Thereby, this SDE using PC as solvent can be designed, by introducing five different commercial salts, aiming for a robust SEI that prevents PC co-intercalation and pro-motes charge/ion transfer over the SEI.

A further experiment is performed. Firstly, the lithium-ion solvation environment of the electrolytes is studied using nuclear magnetic resonance (NMR) spectroscopy, where the chemical shift reflects the shielding of the lithium-ions as a result of the solvation environment. The 0.6 M LiTFSI-DME, 0.6 M LiFSI-DME and 0.6 M LiDFOB-DME single-salt electrolytes result in more negative shifts of −1.19, −1.17 and −0.73 ppm, respectively. In this case the lithium-ions thus experience relatively strong shielding due to a high electron density, indicating a stronger solvation interaction with both solvent and anions. In contrast, a downfield shift for the 0.6 M HE-DME electrolyte is observed, at −0.68 ppm, demonstrating a relatively lower shielding of the lithium-ions, which may promote lithium-ion diffusivity based on a weaker solvation interaction. The 0.6 M HE-DME shows to be stable up to ~4.51 V, higher than the single salt (4.36 V for 0.6 M LiFSI-DME), where the subsequent capacity increase is suggested to be due to the formation of a cathode electrolyte interphase (CEI) on the surface of the cathode. Measurement of the lithium-ion transference number and conductivity of the 0.6 M HE-DME electrolyte, result in 0.46 and ~12.1 mS cm⁻¹, respectively. This improved rate performance can directly be related to the higher transference number and conductivity of the 0.6 M HE-DME electrolyte. It should be emphasized that the conductivity of the 0.6 M HE-DME electrolyte is higher than that of the electrolytes with individual salts, showing that the combination of salts appears to result in a higher diffusivity.

The upper cut-off voltage is challenging for the DME solvent because its relatively low oxidation stability. In combination with the 0.6 M LiFSI-DME electrolyte, Li∥NCM811 cells are not able to reach the cut-off voltage of 4.3 V at a current density of C/10, presumably because the cathode results in undesired oxidation of the electrolyte, catalysed by the formed high-valence Ni species upon de-lithiation (charging). In comparison, the 0.6 M HE-DME electrolyte shows significantly improved reversible cycling when charged to 4.3 V, where two reproducible cells deliver similar charge/discharge profiles with a specific capacity of 182 mAh g⁻¹. These results further support the DME is responsible for the capacity decay for high-voltage cathodes, but mixing of several salts in the high entropy electrolyte demonstrates substantial improvements and promising application potential.

In the 0.6 M HE-DME electrolyte, large lithium metal particles with thin SEI (approximately 6 nm thick) are observed, which is different from the whisker and needle-like lithium metal depos-its with thicker and non-uniform SEI (approximately 10 nm thick) in 0.6 M LiFSI-DME electrolyte. Being inorganic-dominant, this indicates that more anionic groups participate in the SEI formation for the 0.6 M HE-DME electrolyte. In the 0.6 HE-DME electrolyte, large spherical crystallites are observed, with the (110) planes parallel to Cu substrate. This is consistent with a previous study which indicated that this crystalline texturing is beneficial to increase the homogeneity of lithium growth. It signifies that after nucleation, lithium-ion transport facilitates the regular and homogeneous lithium-metal growth in the 0.6 HE-DME electrolyte.

The HE-DME electrolyte shows a weaker solvation interaction between lithium ions and the DME solvent, indicated by the decreased peak intensity at ~2.22 eV, compared with the single-salt electrolytes. In line with this, the ⁷Li chemical shift of the 0.6 M HE-DME electrolyte indicates weaker shielding and therefore weak solvation; even weaker than a dilute 0.05 M LiFSI-DME electrolyte.

The HE electrolyte introduces a diversity in anion species, which in turn are expected to result in a larger variety of solvation structures, weakening the interaction between lithium ions and DME/anions as inferred above from NMR. To gain more insights into the solvation structure, density functional theory (DFT) and molecular dynamics (MD) simulations were carried out. The various principal anion species in the 0.6 M HE-DME electrolyte result in a rich diversity of more than 30 types of lithium-ion solvation environments, much more than what is predicted for the 0.6 M LiFSI-DME electrolyte. The simulated self-diffusion coefficient of 2.3×10⁻⁶ cm² s⁻¹ is larger than that of the 0.6 M LiFSI-DME electrolyte, indicating improved lithium-ion mobility in agreement with the measured conductivity.

The solvation structure of the liquid electrolyte plays a dominant role in the charge transfer between electrolyte and the electrode as well as in the SEI formation, where the resulting SEI morphology and composition determine the lithium-ion transport through the SEI. According to the radial distribution function (RDF) of the 0.6 M LiFSI-DME electrolyte obtained from the MD simulations, oxygen shows a strong tendency to coordinate with the lithium-ion in comparison to the other elements, indicating a relatively strong interaction between lithium ions and solvent molecules. However, in the HE-DME electrolyte, fluorine and nitrogen also coordinate with lithium ions, indicating more anion rich solvation structures. This rationalizes the observation that for the HE electrolyte, both the SEI on anode and the CEI on the cathode are rich in decomposed salt anions. These salt anions, responsible for the higher electrochemical stability, facilitate lithium-ion transfer between the electrolyte and SEI/CEI and most likely also a higher lithium-ion conductivity in both the SEI and CEI. As for the SEI-electrolyte interface, the large diversity in solvation structures in the HE electrolyte leads to a wider range of solvation energies, as indicated by DFT. This diversity results in lower solvation reorganization energies that facilitate lithium-ion diffusion as well as charge transfer towards the interphase are found. The de-solvation processes in the entropy-dominated and conventional dilute electrolyte are further found. In the HE electrolyte, the inorganic rich SEI/CEI and improved lithium-ion kinetics are attributed to the higher entropy, resulting in more dense lithium metal growth, despite the low concentration of HE electrolyte. Based on the above results, the characteristics of conventional dilute electrolytes, high salt concentration electrolytes and HE electrolytes are compared. From this comparison, the HE demonstrates promising assets, especially realizing that it enables improved stability against the anode/cathode in with low salt concentration liquid electrolytes, typically achieved only with highly concentrated electrolytes.

X-ray diffraction pattern demonstrates the pure phase of this prepared NCM811 cathode.

### General Priority in Salt/Solvent Selection, Based on Applicability:

### For Li/Na Metal Anode:

Salts: Salts contains more oxygen in the anion group can help decrease the interaction with Li⁺/ Na⁺ and solvents, such as Lithium difluoro(oxalato)borate (LiDFOB), LiNO₃, etc. which are favourable for Li⁺/ Na⁺ diffusion in the electrolyte. At the same time, the increased interaction between Li⁺/ Na⁺ and anion can lead to an anion-dominated inorganic-rich SEI that facilitate Li⁺/ Na⁺ transport in the interphase. The improved interphase properties can further influence the Li/Na metal deposition morphology and the cathode stability. Salts contains F and N in the anion group is benefit for the composition in the interphase that.

### For Low Temperature Application:

Solvent: To increase the ionic conductivity of electrolytes at low temperatures, solvents with lower freezing point and viscosity is preferred, such as linear carbonates (EMC, DEC etc.), carboxylate solvents with different chain length (methyl acetate (MA) and ethyl acetate (EA), etc.), ether solvents (DME, DOL, etc.). Moreover, other co-solvents, such as AN, propionitrile (PN), or butyronitrile (BN) can be also used to improve the low-temperature performance.
Salt: Li/Na salts critically affect the low-temperature performance of electrolytes via altering the solvation degree and SEI-formation capability of the anions. Therefore, Li salts benefiting SEI formation or with higher conductivity can be used for low-temperature application, such as LiDFOB, LiBF₄, LiTFSI, LiFSI, LiAsF₆, etc.

### For High-Voltage Application:

Solvent: To improve the high-voltage stability of the electrolyte, mixed carbonates solvents such as EC/DMC etc, fluorinated solvent such as FEC, FEMC, etc. and sulfones such as EMS, TMS, etc. can be used.
Salt: Increasing the salt concentration can widen the potential window of the electrolytes. It seems that a threshold exists with the salt-to-solvent molar ratio of 1:2, where larger salt content should be reach to enable high-voltage application. Salts such as LiTFSI, LiFSI, LiPF₆ can be used.

### For Fast-Charge Application:

Solvent: To improve the rate performance of the battery, the solvation and desolvation activation energies of Li⁺ in electrolytes need to be reduced. In this context, low-viscosity co-solvents such acetonitrile (AN), propionitrile (PN), and butyronitrile (BN) can be used.
Salt: To improve the Li⁺ transference number, improving the salt concentration or Li salt with larger anion group can be used.
List of Possible Anodes and Cathodes Where this Could be Applied:

### Anodes:

Alloy anodes (such as Aluminum (Al), Tin (Sn), Magnesium (Mg), Silver (Ag), Antimony (Sb), and their alloys).
Conversion-type anode materials include transition-metal sulphides, oxides, phosphides, nitrides, fluorides, and selenides.
Silicon-based compounds
Carbon based compounds
Li/Na metal anode

### Cathode:

LiFePO₄
LiFeₓMn₁₋ₓPO₄LiMn₂O₄ spinel
LiNi_{0.5}Mn_{1.5}O₄ spinel
LiNiₓCo_{y}Mn_{1-x-y}O₂ layered oxides
Li-rich layered oxides

For experimental results reference is also made to articles submitted for publication, with titles “Entropy-driven liquid electrolytes for lithium batteries”, and “Entropy-engineered solvation interactions achieving stable interphases for lithium-battery liquid electrolytes”, which articles and their contents are incorporated by reference.

1. A high entropy liquid electrolyte for a single valence cation battery, comprising
at least one solvent, and
at least 5 single valence salts dissolved in the at least one solvent, forming a liquid electrolyte, wherein each individual first single valence salt is different from each individual second single valence salt, wherein each single valence salt individually comprises the same single valence cation, and for each single valence salt an anion being different from the anions of the other of the at least 5 single valence salts.

2. The high entropy liquid electrolytes for a Single valence cation battery according to claim 1, wherein the cation is selected from Li⁺ and Na⁺.

3. The high entropy liquid electrolytes for a single valence cation battery according to claim 1, wherein the anion is selected from oxides, from carboxylic acid residues, from weak acid residues, from sulphides, from sulfonyl compounds, from alkane compounds, from fluoro compounds, from phosphorous compounds, from imide compounds, from amide compounds, from borate compounds, from phosphate compounds, and from combinations thereof.

4. The high entropy liquid electrolytes for a Single valence cation battery according to claim 1, wherein the at least one solvent is selected from carbonates, from carboxylates, from ethers, from ethers, from esters, from nitriles, from water, from alcohols, from sulfones, from sulfoxides, from sulphites, from anhydrides, from fluorinated solvents, from ketones, from ionic liquids, from nitriles, from silicates, and from aldehydes, and from combinations thereof.

5. The high entropy liquid electrolytes for a Single valence cation battery according to claim 1, wherein the concentration of each individual single valence salt is 0.01-5 mole/l, and
wherein at least one first single valence salt of the at least four single valence salts is present in a concentration of 0.1-2.5 mole/l, and
wherein at least one second single valence salt of the at least four single valence salts is present in a concentration of <50% of the concentration of the at least one first single valence salt, and
wherein at least one third single valence salt of the at least four single valence salts is present in a concentration of <50% of the concentration of the at least one first single valence salt, and
wherein at least one fourth single valence salt of the at least four single valence salts is present in a concentration of <50% of the concentration of the at least one first single valence salt.

6. The high entropy liquid electrolytes for a Single valence cation battery according to claim 1, wherein a total concentration of the at least four single valence salts is 0.1-10 mole/l.

7. The high entropy liquid electrolytes for a Single valence cation battery according to claim 1, comprising 5-12 single valence salts dissolved in the at least one solvent.

8. The high entropy liquid electrolytes for a Single valence cation battery according to claim 1, wherein at least one fifth single valence salt of the at least four single valence salts is present in a concentration of <50% of the concentration of the at least one first single valence salt, and
wherein at least one sixth single valence salt of the at least four single valence salts is present in a concentration of <50% of the concentration of the at least one first single valence salt, and
wherein at least one seventh single valence salt of the at least four single valence salts is present in a concentration of <50% of the concentration of the at least one first single valence salt, and
wherein at least one eighth single valence salt of the at least four single valence salts is present in a concentration of <50% of the concentration of the at least one first single valence salt and
wherein at least one optional further single valence salt of the at least four single valence salts is present in a concentration of <50% of the concentration of the at least one first single valence salt.

9. The high entropy liquid electrolytes for a Single valence cation battery according to claim 1, wherein the electrolyte comprises >0.05 M of a low soluble salt, wherein the low soluble salt is selected from LiNO₃, Lithium difluoro(oxalato)borate (LiDFOB), and combinations thereof.

10. The high entropy liquid electrolytes for a Single valence cation battery according to claim 1, wherein the at least one solvent comprises a compound selected from poly ethylene carbonate, ethylmethyl carbonate, di-ethyl carbonate, methyl acetate, ethyl acetate, di-methyl ether, 1,3-dioxolane, acetonitrile, propionitrile, butyronitrile, and combinations thereof.

11. A Single valence cation battery comprising the high entropy liquid electrolytes according to claim 1.

12. The Single valence cation battery according to claim 11, further comprising at least one electrode, in particular at least one anode and at least one cathode, and an electrolyte compartment provided in fluidic contact with the at least one electrode.

13. The Single valence cation battery according to claim 12, wherein the material of the cathode is selected from Fe comprising cathodes, from Mn comprising cathodes, from Li or Na comprising cathodes, from Co comprising cathodes, from transition metal alloys, from Ni comprising cathodes, in particular from nickel comprising alloys, and
wherein the anode comprises a material selected from Al-alloys, from Sn-alloys, from Mg-alloys, from Ag-alloys, from Sb alloys, and from silicon alloys (a-Si_{y}Aₓ:Q_{z}), wherein element A is selected from B, C, N, Ge, O, and combinations thereof, wherein element Q is selected from H, F, and combinations thereof, and from silicon, wherein one of the silicon alloy and silicon is porous for accommodating electrolyte ions, wherein one of the silicon alloy and silicon has a porosity from 1-50%, wherein one of the silicon alloy and silicon is amorphous, and wherein one of the silicon and silicon alloy is hydrogenated, from conversion-type anode materials, in particular from metal sulphides, metal oxides, metal phosphides, metal nitrides, metal fluorides, and metal selenides, from carbon based compounds, and from a Li- and a Na-metal anode.

14. A system for power supply comprising at least one Single valence cation battery according to claim 11.

15. The high entropy liquid electrolytes for a Single valence cation battery according to claim 1, wherein the battery is a rechargeable battery.

16. The high entropy liquid electrolytes for a Single valence cation battery according to claim 1, wherein the concentration of each individual single valence salt is 0.05-4 mole/l.

17. The high entropy liquid electrolytes for a Single valence cation battery according to claim 1,
wherein at least one first single valence salt of the at least four single valence salts is present in a concentration of 0.1-2.5 mole/l,
wherein at least one second single valence salt of the at least four single valence salts is present in a concentration of <50% of the concentration of the at least one first single valence salt,
wherein at least one third single valence salt of the at least four single valence salts is present in a concentration of <25% of the concentration of the at least one first single valence salt, and
wherein at least one fourth single valence salt of the at least four single valence salts is present in a concentration of <25% of the concentration of the at least one first single valence salt.
